(19) United States
(12) Patent Application Publication
(10) Pub. No.: US 2026/0338633 A1
(43) Pub. Date: Oct. 29, 2026

(54) DETECTION DEVICE AND TEST ASSEMBLY

(71) Applicant: Foxconn Internet Advanced Technology (Shaoxing) Co., Ltd., Shaoxing (CN)

(72) Inventors: MING-YUAN WU, Shaoxing (CN); Chun-Yu Shih, New Taipei (TW); Dong-Sheng Chen, Shaoxing (CN)

(21) Appl. No.: 19/640,581

(22) Filed: Apr. 7, 2026

(30) Foreign Application Priority Data
Apr. 9, 2025 (CN) 202520665127.9

(51) Int. Cl. G01M 3/28

(52) U.S. Cl. CPC G01M 3/2815

(57) ABSTRACT

The present application discloses a detection device and a test assembly. The detection device includes a carrier frame, a piping assembly and a plurality of sensing elements. The carrier frame includes a support bracket and a plurality of bearing members sequentially arranged on the support bracket at intervals; each of the sensing elements is carried on a corresponding bearing members; the sensing element detects parameters of a medium flowing. The piping assembly is connected to each of the sensing elements, and is connected to a supply member, and is connected to a plurality of test pieces. The medium flows through the sensing element into the test piece and then returns to the sensing element. The plurality of sensing elements can simultaneously test the plurality of test pieces.

### FIELD

The subject matter relates to detection for liquid-cooled equipment, and more particularly, to a detection device and test assembly.

### BACKGROUND

When testing liquid-cooled equipment, the airtightness of the liquid-cooled equipment is typically tested by measuring its air pressure or hydraulic pressure. In the related art, it is difficult to test multiple liquid-cooled devices simultaneously, resulting in low detection efficiency.

Therefore, there is room for improvement in the art.

### BRIEF DESCRIPTION OF THE DRAWINGS

FIG. 1 is a simplified diagrammatic view of a test assembly according to an embodiment of the present application.

FIG. 2 is a diagrammatic view of a test assembly according to an embodiment of the present application.

FIG. 3 is a diagrammatic view of an interior of a shell of a detection device shown in FIG. 2 to an embodiment of the present application.

FIG. 4 is a diagrammatic view of the test assembly in FIG. 3, viewed from another perspective.

FIG. 5 is a partial diagrammatic view of the test assembly in FIG. 3.

FIG. 6 is a connection diagrammatic view of a test piece and a sensing element in FIG. 2.

FIG. 7 is a partial diagrammatic view of area A in FIG. 4.

### DETAILED DESCRIPTION

Implementations of the present technology will now be described, by way of example only, with reference to the attached figures.

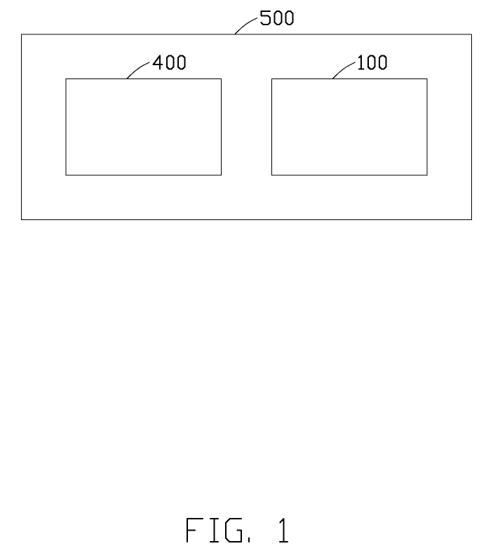

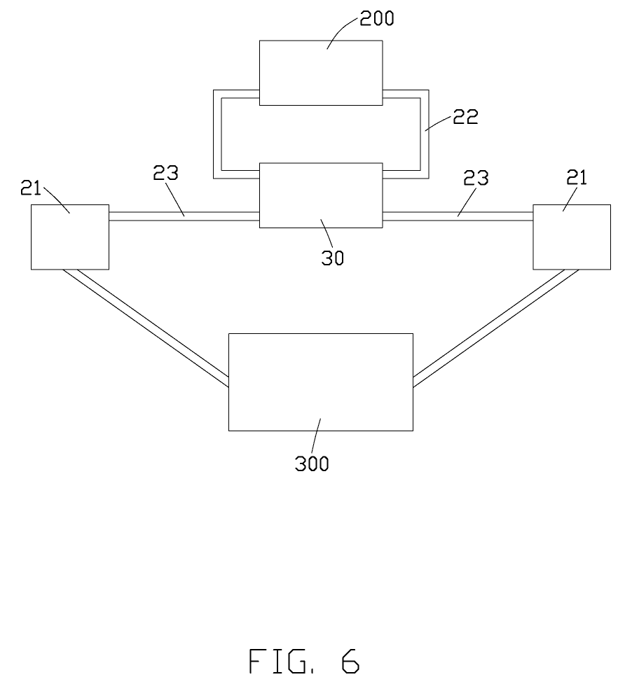

Referring to FIG. 1, an exemplary embodiment of the present application provides a test assembly 500, and the test assembly 500 includes a transfer mechanism 400 and a detection device 100. The transfer mechanism 400 is configured for carrying a plurality of test pieces 200 showed in FIG. 6, and the plurality of test pieces 200 could be placed in a stacked manner. For the convenience of description hereinafter, the stacking direction of the plurality of test pieces 200 is defined as a first direction Z.

In an embodiment, the first direction Z is parallel to the plumb direction, but is not limited thereto.

In an embodiment, the test piece 200 is a liquid cooling equipment. For example, the test piece 200 is a server or a cabinet. The detection device 100 is configured for testing the air tightness of the test piece 200.

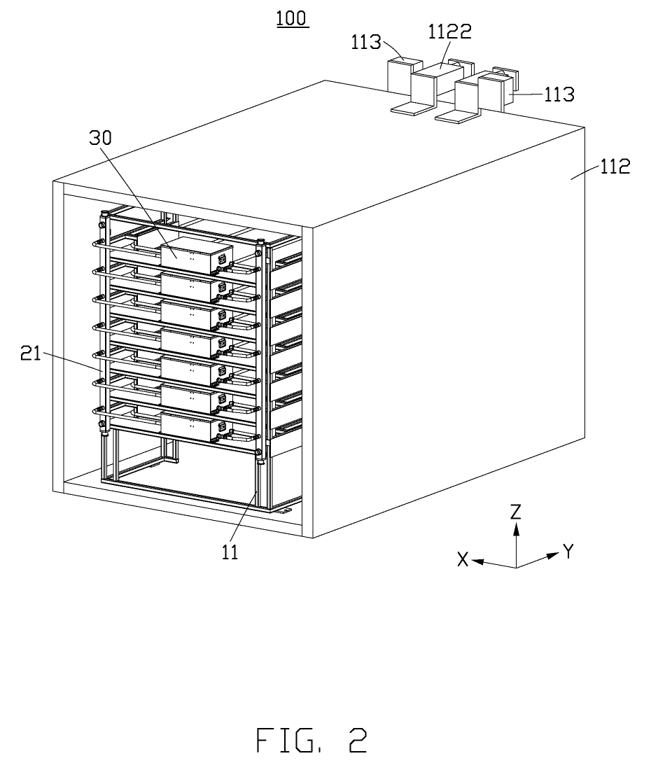

Please refer to FIGS. 2, 3 and 4, in an embodiment, the detection device 100 includes a carrier frame 10, a piping assembly 20 and a plurality of sensing elements 30. The carrier frame 10 carries the plurality of sensing elements 30. The piping assembly 20 connects each of the plurality of sensing elements and a corresponding test piece 200 of the plurality of test pieces 200. The sensing element 30 is configured for detecting parameters of the medium, for example, the parameters may be the pressure and flow rate of the medium flowing through the sensing element 30.

The carrier frame 10 includes a support bracket 11 and a plurality of bearing members 12. In an embodiment, the support bracket 11 is mounted on the ground, but is not limited thereto. For example, in another embodiment, the support bracket 11 is mounted on a frame. The plurality of bearing members 12 are fixedly connected to the support bracket 11, and the plurality of bearing members 12 are arranged at intervals along the first direction Z. Each bearing member 12 carries one sensing element 30. The plurality of bearing members 12 connected to the support bracket 11 could carry the plurality of sensing elements 30, saving the area of the occupied space of the detection device 100 in the direction perpendicular to the first direction Z.

The plurality of sensing elements 30 are arranged along the first direction Z, so as to be in one-to-one correspondence with the plurality of test pieces 200 stacked along the first direction Z, and each sensing element 30 is configured to test the corresponding test piece 200.

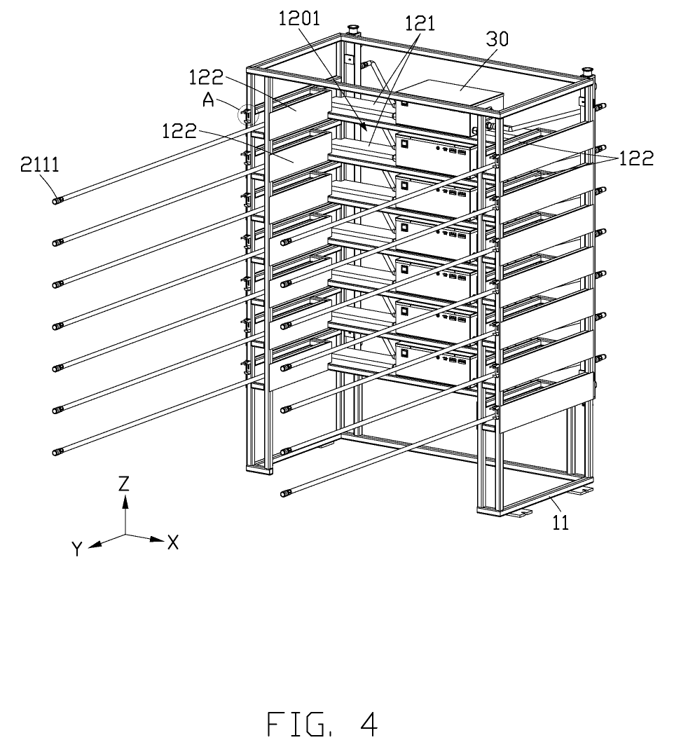

The bearing member 12 includes a bearing portion 121 and an extension portion 122. The bearing portion 121 carries the sensing element 30. The extension portion 122 is connected to the bearing portion 121. In an embodiment, the extension portion 122 and the bearing portion 121 extend along different directions. For example, as shown in FIG. 4, the extension portion 122 extends along a second direction Y, the bearing portion 121 extends along a third direction X, and the second direction Y and the third direction X are respectively perpendicular to the first direction Z.

The support bracket 11 is further configured for connecting the transfer mechanism 400, so that each test piece 200 could correspond to the extension portion 122 of one bearing member 12, that is, in the first direction Z, each test piece 200 corresponds to one sensing element 30.

In an embodiment, the bearing member 12 includes two extension portions 122, and the two extension portions 122 are located on opposite sides of the bearing portion 121 along the third direction X.

The piping assembly 20 is connected with each of the sensing elements 30, and is configured to be connected with the supply member 300 so that the medium provided by the supply member 300 could enter each of the sensing elements 30, and is configured to be connected with a plurality of test pieces 200 so that each of the sensing elements 30 is communicated with a corresponding one of the test pieces 200. The medium flows through the sensing element 30 into the test piece 200 and then reflows to the sensing element 30.

In an embodiment, the supply member 300 is a multi-functional liquid-gas testing machine, and the multi-functional liquid-gas testing machine is configured for outputting the medium.

In an embodiment, the medium is gas, and the sensing element 30 measures the air pressure of the medium twice before and after entering the test piece 200, so as to compare and judge the air tightness of the test piece 200. The closer the two measured medium values are, the less gas leaks from the test piece 200, and the better the air tightness of the test piece 200 is.

In another embodiment, the medium is liquid, and the sensing element 30 measures the liquid hydraulic pressure or liquid flow rate before and after entering the test piece 200. The closer the two measured medium values are, the better the air tightness of the test piece 200 is.

In an embodiment, the medium may be gas and liquid configured for assisting the sensing element 30 in detecting air tightness. The medium is gas or liquid injected into the test piece 200. The sensing element 30 could be configured for detecting the injection amount of the medium injected into the test piece 200, so as to judge whether the test piece 200 is qualified.

In an embodiment, the sensing element 30 is an integrated sensor, and the sensing element 30 includes a pressure sensor and a flow sensor. When the medium is gas, the pressure sensor is configured for detecting the pressure of the piping assembly 20, so as to judge whether the test piece 200 leaks the medium, thereby measuring the air tightness of the test piece 200. When the medium is liquid, the flow sensor is configured for detecting the flow rate of the medium in the piping assembly 20, and obtain the flow velocity of the medium by dividing the flow rate by the cross-sectional area of the pipeline, so as to judge whether the test piece 200 leaks the medium, thereby measuring the air tightness of the test piece 200.

In an embodiment, if the standard capacity of the test piece 200 is known, the sensing element 30 detects the amount of the medium filling the test piece 200, and the performance of the test piece 200 could be measured according to the difference between the standard capacity and the amount of the medium filling the test piece 200 measured by the sensing element 30.

In an embodiment, the sensing element 30 is configured for detecting the values of the medium before and after entering the test piece 200, and the performance of the test piece 200 could be measured according to the difference between the values of the medium before entering the test piece 200 and after entering the test piece 200 measured by the sensing element 30.

The piping assembly 20 includes a plurality of third pipelines 21 and a plurality of second pipelines 22. The third pipeline 21 extends along the first direction Z and is arranged on the support bracket 11.

Every two second pipelines 22 are arranged corresponding to one bearing member 12, that is, every two second pipelines 22 of the plurality of second pipelines 22 form a group to form a plurality of groups of second pipelines, the plurality of groups of second pipelines are arranged along the first direction Z, each of the two second pipelines 22 in each group is connected between the test piece 200 and the sensing element 30, and the medium could flow between the second pipeline 22 and the sensing element 30, and between the second pipeline 22 and the test piece 200, facilitating the connection between the sensing element 30 and the test piece 200 corresponding to the same bearing member 12. Each test piece 200 and the corresponding sensing element 30 form a loop through two second pipelines 22.

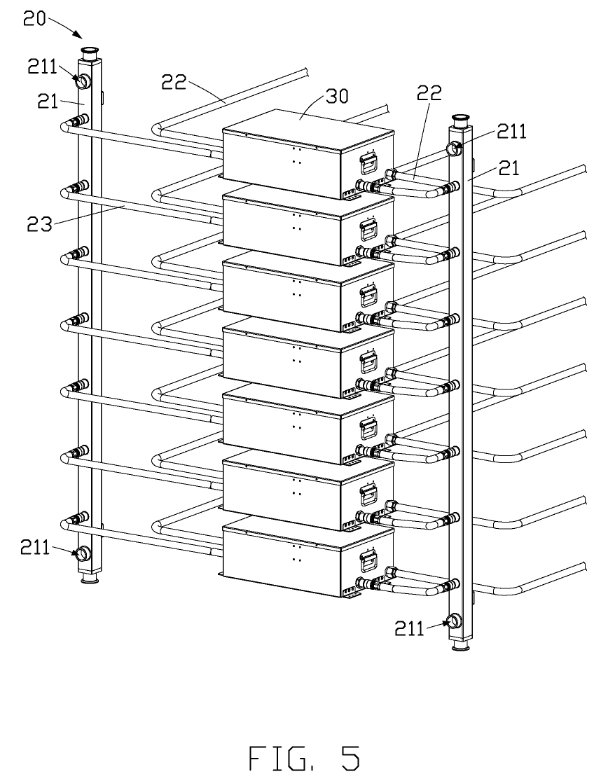

Referring to FIGS. 5 and 6, the third pipeline 21 is provided with a joint 211, and the joint 211 is configured for connecting the supply member 300, so that the medium provided by the supply member 300 enters the third pipeline 21 through the joint 211. The third pipeline 21 is communicated with the corresponding sensing element 30, so that the medium could enter the sensing element 30 from the third pipeline 21 or enter the third pipeline 21 from the sensing element 30.

In an embodiment, there are two third pipelines 21, the two third pipelines 21 are arranged on the support bracket 11 at intervals along the third direction X, the medium could enter the supply member 300 from the sensing element 30 through one third pipeline 21, and could reflow to the sensing element 30 from the supply member 300 through the other third pipeline 21.

In use, the supply member 300 feeds the medium into one third pipeline 21 through the joint 211 of one third pipeline 21, and the medium enters the sensing element 30, so that the sensing element 30 initially detects the value of the medium; each sensing element 30 could form a closed loop with one test piece 200, so that the medium after entering the sensing element 30 enters the test piece 200 through one second pipeline 22 and then enters the sensing element 30 again through the other second pipeline 22, so that the sensing element 30 detects the value of the medium again. In this way, the sensing element 30 measures the value of the medium twice, the first time measuring the value before entering the test piece 200, and the second time measuring the value after entering the test piece 200, and the performance of the test piece 200 could be measured according to the two measured medium values.

The plurality of bearing members 12 could carry the plurality of sensing elements 30 and correspond to the plurality of test pieces 200, and each test piece 200 could form a closed loop with the corresponding sensing element 30 through two second pipelines 22. By feeding the medium into the joint 211, each sensing element 30 could measure the performance of one test piece 200, that is, the plurality of sensing elements 30 could simultaneously test the plurality of test pieces 200 respectively, improving the testing efficiency.

In an embodiment, the sensing element 30 further includes a temperature and humidity sensor. The temperature and humidity sensor could detect the temperature and humidity in the piping assembly 20, so as to detect the dryness, and judge whether the piping assembly 20 is dried when the supply member 300 dries the piping assembly 20.

Therefore, the sensing element 30 has a variety of monitoring capabilities, covering gas-liquid pressure, flow rate, flow velocity and environmental dryness at the same time, enabling multi-parameter collaborative verification, improving data reliability, adapting to gas-liquid media, and having good versatility.

In an embodiment, the piping assembly 20 further includes a plurality of first pipelines 23. Each third pipeline 21 is communicated with the sensing element 30 through one first pipeline 23.

The first pipeline 23 is in threaded connection with both the third pipeline 21 and the sensing element 30, facilitating the disassembly and replacement of the first pipeline 23. The second pipeline 22 is in threaded connection with the test piece 200 and the sensing element 30, facilitating the disassembly and replacement of the second pipeline 22.

In an embodiment, the third pipeline 21 could be omitted, and the first pipeline 23 is directly connected to the supply member 300.

In an embodiment, when the sensing element 30 tests the test piece 200, the sensing element 30, the corresponding test piece, the two second pipelines 22 and the two first pipelines 23 located on both sides of the sensing element 30 form a liquid flow path. The medium provided by the supply member 300 enters through the joint 211 of one third pipeline 21, and sequentially flows through the corresponding first pipeline 23, the sensing element 30, the second pipeline 22, the test piece 200, the other second pipeline 22, the sensing element 30, the other first pipeline 23, the other third pipeline 21, and is discharged to the outside of the detection device 100 or to the supply member 300 through the joint 211 of the other third pipeline 21.

Referring to FIG. 6, in an embodiment, the joints 211 of the two third pipelines 21 are both connected to the supply member 300, and the supply member 300 enters through the joint 211 of one third pipeline 21 and flows back to the supply member 300 through the joint 211 of the other third pipeline 21, facilitating the recycling of the medium.

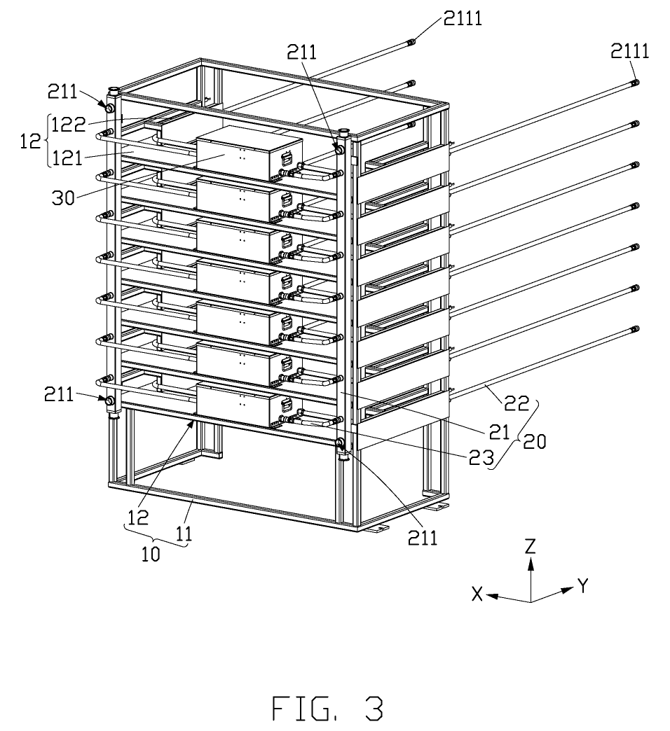

Referring to FIGS. 3-5, in an embodiment, each third pipeline 21 is provided with two joints 211 at intervals along the first direction Z. The two third pipelines 21 are both connected to the supply member 300 through one joint 211. When one joint 211 in one third pipeline 21 is configured for inputting the medium, one joint 211 in the other third pipeline 21 is configured for outputting the medium.

When the medium is liquid, the lower joint 211 of the two joints 211 of the third pipeline 21 inputs the medium, so that the medium is filled from the bottom to the top to reduce bubbles and avoid bubble interference, the liquid flows downward under the action of gravity, and the upper joint 211 of the two joints 211 of the third pipeline 21 outputs the medium, which is conducive to the medium being output after filling the third pipeline 21 and staying for a period of time.

When the medium is gas configured for drying the pipeline, such as heated high-temperature dry gas, the gas could quickly discharge liquid residues in the pipeline and completely dry the residues. The upper joint 211 of the two joints 211 of the third pipeline 21 inputs the medium, and the lower joint 211 of the two joints 211 of the third pipeline 21 outputs the medium. The dry gas enters from the top to form a top-down temperature gradient, the high-temperature area at the top evaporates liquid, and the bottom outlet discharges moisture, which could quickly discharge residual liquids by gravity and efficiently dry by directional hot air flow, ensuring that the pipeline is completely dry through detection by the sensing element 30.

Therefore, by providing two joints 211 on each third pipeline 21, the user could select to use the upper joint 211 and the lower joint 211 according to actual conditions, which is suitable for various media.

In an embodiment, a liquid level sensor is provided in the third pipeline 21 to judge the liquid level height of the medium.

Referring to FIG. 3, in an embodiment, one end of the second pipeline 22 for connecting the test piece 200 and the joint 211 of the third pipeline 21 are both provided with connectors 2111. The connector 2111 at the joint 211 is inserted into the supply member 300 to communicate the third pipeline 21 with the supply member 300, and the connector 2111 is further configured for closing the joint 211 in responding to the supply member 300 being pulled out. The connector 2111 at the end of the second pipeline 22 is configured for inserting the test piece 200 to communicate the second pipeline 22 with the test piece 200, and the connector 2111 is further configured for closing the second pipeline 22 in responding to the test piece 200 being pulled out.

The connector 2111 closes the joint 211 and the second pipeline 22 to prevent air from entering the third pipeline 21 or the second pipeline 22 to affect the air tightness of the piping assembly 20, and further prevent external pollutants from entering the third pipeline 21 or the second pipeline 22 to pollute the piping assembly 20, thereby affecting the detection results.

In an embodiment, the connector 2111 includes a self-sealing quick-connect coupling.

Referring to FIG. 4, in an embodiment, each bearing member 12 includes two extension portions 122. The two extension portions 122 are respectively connected to opposite ends of the bearing portion 121 along the third direction X, so that the two extension portions and the bearing portion 121 enclose a substantially u-shaped receiving groove 1201. The plurality of bearing members 12 form a plurality of receiving grooves 1201. When the transfer mechanism is connected to the support bracket 11, the receiving groove 1201 accommodates the test piece 200, and the plurality of receiving grooves 1201 could accommodate the plurality of test pieces 200, thereby facilitating the simultaneous detection of the plurality of test pieces 200.

The plurality of bearing members 12 are stacked so that the space formed by the plurality of receiving grooves 1201 could accommodate the transfer mechanism 400, so that the transfer mechanism 400 could be embedded in the support bracket 11, facilitating the alignment and connection between the transfer mechanism 400 and the detection device 100. The support bracket 11 and the extension portion 122 limit the movement of the transfer mechanism in the third direction X to prevent the transfer mechanism 400 from shaking relative to the sensing element 30.

In an embodiment, the overall outer contour of the connected transfer mechanism 400 and detection device 100 is rectangular, with a compact structure.

In the illustrated embodiment, the second direction Y is perpendicular to the third direction X.

In an embodiment, both the bearing portion 121 and the extension portion 122 are flat plates. The sensing element 30 is fixedly connected to the bearing portion 121 by bolts.

In an embodiment, each second pipeline 22 is located on one side of the bearing member 12 along the first direction Z, so as to facilitate the second pipeline 22 to connect the test piece 200 located in the receiving groove 1201.

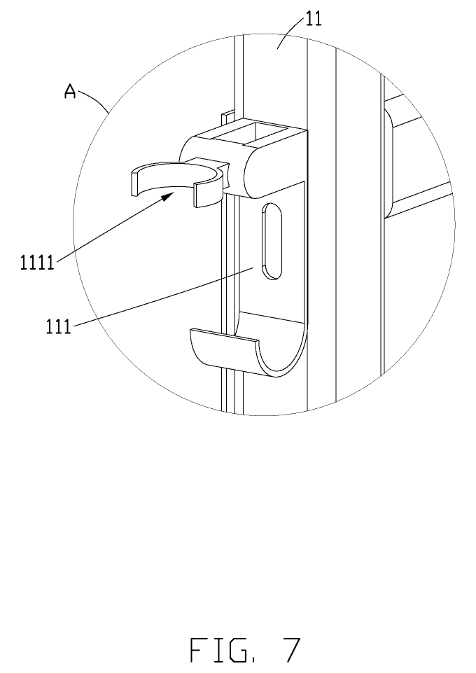

Referring to FIGS. 4 and 7, in an embodiment, the support bracket 11 is provided with a plurality of fastening clips 111. The plurality of fastening clips 111 are divided into two groups along the third direction X and arranged on opposite sides of the receiving groove 1201. The plurality of fastening clips 111 in each group are arranged at intervals along the first direction Z, and one fastening clip 111 is arranged on the support bracket corresponding to each bearing member 12. The fastening clip 111 is provided with a clamping groove 1111, and the clamping groove 1111 is configured for clamping the second pipeline 22.

The plurality of fastening clips 111 arranged along the first direction Z position the plurality of second pipelines 22 in one-to-one correspondence with the plurality of bearing members 12.

The fastening clip 111 positions a part of the second pipeline 22 at a position corresponding to the bearing member 12, thereby facilitating the positioning of the second pipeline 22 and the test piece 200 corresponding to the same bearing member 12, and reducing the risk of the second pipeline 22 being incorrectly connected to a non-corresponding test piece 200.

The second pipeline 22 could be a pipeline made of hard material or soft material, for example, the second pipeline 22 is a metal pipe or a plastic pipe.

In an embodiment, the cross section of the second pipeline 22 is cylindrical. The clamping groove 1111 is a half circular ring shape to adapt to the shape of the second pipeline 22. The second pipeline 22 could be in other shapes, for example, the cross section of the second pipeline 22 could be elliptical.

In an embodiment, the fastening clip 111 is provided with two clamping grooves 1111, one clamping groove 1111 extends along the first direction Z, and the other clamping groove 1111 extends along the third direction X. When the transfer mechanism is not connected to the support bracket 11, the second pipeline 22 is clamped in the clamping groove 1111 extending along the third direction X, so that the second pipeline 22 could be inserted into the test piece 200 in the corresponding receiving groove 1201 after the transfer mechanism is embedded in the support bracket 11. After the second pipeline 22 is inserted into the test piece 200, the second pipeline 22 is clamped in the clamping groove 1111 extending along the first direction Z to organize the second pipeline 22 and reduce the risk of the second pipeline 22 being too long and winding.

Referring to FIG. 2, in an embodiment, the outer periphery of the support bracket 11 is provided with a shell 112 to protect the support bracket 11, as well as the piping assembly 20 and the sensing element 30 arranged on the support bracket 11.

In an embodiment, the support bracket 11 is provided with an alignment sensor, and the alignment sensor is configured for sensing the position of the test piece 200 in the receiving groove 1201, so as to determine whether the transfer mechanism 400 moves to a set position, and realize the connection between the test piece 200 and the piping assembly 20.

The alignment sensor is arranged on a side of the shell 112 close to the receiving groove 1201. The bottom of the transfer mechanism 400 is provided with rollers, and the transfer mechanism 400 could slide into the shell 112 to be embedded in the plurality of receiving grooves 1201, so that each sensing element 30 corresponds to one test piece 200. The alignment sensor senses that the transfer mechanism is moved in place.

In an embodiment, the alignment sensor is a laser displacement sensor or a vision sensor, which is not limited in the present application.

In an embodiment, the shell 112 is further provided with a sensing groove, and the sensing groove is arranged on a side of the shell 112 close to the receiving groove 1201. The transfer mechanism is provided with a sensing plate. When the alignment sensor senses that the transfer mechanism 400 is moved to a set position, the sensing plate enters the sensing groove. The arrangement of various sensors could more accurately position the transfer mechanism 400 and the support bracket 11.

In an embodiment, a side of the support bracket 11 close to the extension portion 122 is provided with a telescopic member 113, as shown in FIG. 2. The telescopic member 113 is fixedly arranged on the shell 112. After the receiving groove 1201 accommodates the test piece 200, the telescopic member 113 extends along the first direction Z. When the test piece 200 moves away from the bearing portion 121 along the second direction Y, the telescopic member 113 stops the test piece 200 to stop the test piece 200 in the receiving groove 1201, thereby limiting the test piece 200 from separating from the receiving groove 1201.

In an embodiment, the telescopic member 113 is a piston cylinder. When the alignment sensor senses that the transfer mechanism 400 is moved in place, and the transfer mechanism 400 is embedded in the plurality of receiving grooves 1201, the telescopic member 113 extends to make the piston of the piston cylinder stop the transfer mechanism 400, so as to limit the transfer mechanism 400 from moving along the second direction Y away from the plurality of receiving grooves 1201.

In an embodiment, the number of the telescopic members 113 could be two or more, so as to more stably stop the movement of the transfer mechanism 400.

In an embodiment, the shell 112 is provided with a buckle 1122, as shown in FIG. 2. The top of the transfer mechanism 400 is provided with a fitting member, and the buckle 1122 is configured for clamping the fitting member when the moving assembly is embedded in the plurality of receiving grooves 1201.

In an embodiment, the fitting member is a hook, and the buckle 1122 clamps the hook to limit the transfer mechanism 400 from moving along the second direction Y away from the support bracket 11 and out of the plurality of receiving grooves 1201, and prevent the transfer mechanism 400 from shaking, so that the transfer mechanism 400 could be stably located in the shell 112.

In an embodiment, the buckle 1122 is an elastic buckle, and the buckle 1122 could be manually toggled to separate the buckle 1122 from the fitting member. The buckle 1122 could be driven by an electric structure to separate the buckle 1122 from the fitting member. The electric structure could include an electric cylinder, which drives the buckle 1122 to move along the first direction Z to clamp the fitting member, and the electric cylinder could drive the buckle 1122 to return along the first direction Z to release the clamping of the fitting member.

The terms configured in the present application, such as “first” and “second”, do not intended to indicate any order, quantity, or importance of related components, but are only configured for differentiation between the related components.

As configured in the present application, the term “a” or “one” do not intended to limit the quantity of the related object, but to indicate the existence of at least one related object.

In the present application, the terms indicating direction or position, such as “top”, “bottom”, “side”, “longitudinal”, “transverse”, “middle”, “center, “outer”, “inner”, “horizontal”, “vertical”, “left”, “right”, “upper”, and “lower”, refers to a relative position rather than an absolute position.

The terms configured in the present application, such as “substantially”, “whole”, “approximate”, and “similar”, are intended to indicate that the object has related characteristics but allow for certain deviations. The deviation may depend on a specific background. For example, the dimension of deviation may depend on a specific background, including but not limited to national standards for dimensional tolerances.

What is claimed is:

1. A detection device comprising:
a carrier frame, comprising:
a support bracket;
a plurality of bearing members arranged on the support bracket at intervals and in sequence;
a plurality of sensing elements, each of the sensing element carried on a corresponding bearing member of the plurality of bearing members; the plurality of sensing elements configured for detecting parameters of a medium flowing through the plurality of sensing elements;
a piping assembly connected to each of the plurality of sensing elements, and configured for connecting to a supply member supplying the medium, each of the plurality of sensing elements receiving the medium via the piping assembly, the piping assembly further configured for connecting to a plurality of test pieces, each of the plurality of sensing elements communicating with a corresponding test piece of the test pieces via the piping assembly, wherein a plurality of circulation passages of the medium is formed from the plurality of sensing elements into the plurality of test pieces and reflowing to the plurality of sensing elements.

2. The detection device to claim 1, wherein the piping assembly comprises:
a plurality of first pipelines, wherein a plurality of groups of first pipelines comprising every two first pipelines of the plurality of first pipelines adjacent to both sides of the same sensing element is formed; the plurality of groups of first pipelines is arranged along a first direction parallel to an arrangement direction of the plurality of bearing members, the two first pipelines in each group of first pipelines are connected to a corresponding sensing element of the plurality of sensing elements, and at least one of the two first pipelines in each group of first pipelines is configured for connecting to the supply member;
a plurality of second pipelines, two second pipelines of the plurality of second pipelines connecting between the corresponding test piece and the sensing element, wherein a circulation passage of the plurality of circulation passages is from the sensing element to one of the two second pipelines to the corresponding test piece and reflowing to the sensing element via another one of the two second pipelines.

3. The detection device to claim 2, wherein the piping assembly further comprises a plurality of third pipelines, each the third pipeline comprising a joint and connected to the plurality of first pipelines, wherein the joint is configured to connect to the supply member, the joint receives the medium from the supply member and circulates the medium into the third pipeline.

4. The detection device to claim 3, further comprising a plurality of connectors, wherein
an end of each of the plurality of second pipelines configured for connecting to the plurality of test pieces and each of the joint are connected with the connector;
a connector of the plurality of connectors is configured to connect to the supply member, and is further configured to close the joint in response to the supply member being pulled out;
a connector of the plurality of connectors is configured to connect to the corresponding test piece, and is further configured to close the second pipeline in response to the test piece being pulled out.

5. The detection device to claim 3, wherein each of the plurality of third pipelines comprises two joints arranged at intervals along the first direction, and the third pipeline is configured to connect to the supply member through one of the two joints.

6. The detection device to claim 1, wherein the bearing member comprises:
a bearing portion; and
two extension portions connected to respective opposite ends of the bearing portion along a third direction;
wherein the bearing portion and the two extension portions form a receiving groove configured to receive the plurality of test pieces along a second direction and to accommodate the plurality of test pieces, each of the second direction and the third direction is perpendicular to a first direction, and the plurality of bearing members is arranged on the support bracket in the first direction.

7. The detection device to claim 6, wherein the support bracket comprises a telescopic member, wherein the telescopic member is configured to extend in response to the receiving groove accommodating the plurality of test pieces, and to stop the plurality of test pieces from moving away from the receiving groove along the second direction.

8. The detection device to claim 2, wherein the support bracket comprises a plurality of fastening clips arranged at intervals along the first direction, the plurality of bearing members is arranged on the support bracket in the first direction, and the plurality of second pipelines is clamped to the plurality of fastening clips.

9. The detection device to claim 8, wherein each of the plurality of fastening clips defines two clamping grooves, one clamping groove of the two clamping grooves extends along a second direction, and another clamping groove of the two clamping grooves extends along a third direction, each of the second direction and the third direction is perpendicular to the first direction, and each of the plurality of second pipelines is clamped in the two clamping grooves of a corresponding fastening clip of the plurality of fastening clips.

10. The detection device to claim 1, wherein each of the plurality of sensing elements comprises a pressure sensor and a flow sensor, the pressure sensor is configured for detecting a pressure of the medium in the piping assembly, and the flow sensor is configured for detecting a flow rate of the medium in the piping assembly.

11. A detection device, comprising:
a carrier frame comprising:
a support bracket;
a plurality of bearing members arranged on the support bracket at intervals and in sequence in a first direction;
a plurality of sensing elements one-to-one correspondingly arranged on the plurality of bearing members;
a piping assembly comprising:
a plurality of second pipelines;
a plurality of third pipelines arranged on the support bracket, extending along the first direction; wherein each of the plurality of third pipelines connects to a corresponding sensing element of the plurality of sensing elements, two second pipelines of the plurality of second pipelines are configured to connect to a test piece and a corresponding sensing element of the plurality of sensing elements, and a circulation loop is formed between the corresponding sensing element, the test piece and two corresponding second pipelines of the plurality of second pipelines; each of the plurality of third pipelines comprises a joint configured for connecting to a supply member, receiving and circulating medium provided by the supply member, and the corresponding sensing element is configured to detect the medium and measure performance of the test piece.

12. The detection device to claim 11, further comprising a plurality of connectors, an end of each of the plurality of the second pipelines configured for connecting to the test piece and each of the joint are connected with the connector;
a connector of the plurality of connectors is configured to connect to the supply member, and is further configured to close the joint in response to the supply member being pulled out;
a connector of the plurality of connectors is configured to connect to the corresponding test piece, and is further configured to close the second pipeline in response to the test piece being pulled out.

13. The detection device to claim 11, wherein each of the plurality of third pipelines comprises two joints arranged at intervals along the first direction, and the third pipeline is configured to connect to the supply member through one of the two joints.

14. The detection device to claim 13, wherein each of plurality of sensing elements comprises a pressure sensor and a flow sensor, the pressure sensor is configured for detecting a pressure of the medium in the piping assembly, and the flow sensor is configured for detecting a flow rate of the medium in the piping assembly.

15. A test assembly, comprising:
a transfer mechanism configured to carry a plurality of test pieces arranged in sequence along a first direction;
a detection device comprising:
a carrier frame detachably connected to the transfer mechanism;
a plurality of sensing elements arranged at intervals along the first direction on the carrier frame, and one-to-one correspondingly connecting to the plurality of test pieces in responding to the transfer mechanism connecting to the carrier frame; wherein the corresponding sensing element is configured to detect a medium flowing through the sensing element;
a piping assembly connected to each of the sensing elements, and configured to be connected to a supply member supplying the medium, each of the plurality of sensing elements receiving the medium via the piping assembly; the piping assembly further configured for connecting to the plurality of test pieces, each of the plurality of sensing elements communicating with a corresponding test piece of the test pieces via the piping assembly, wherein a plurality of circulation passages of the medium is formed from the plurality of sensing element into the plurality of test piece and reflowing to the plurality of sensing elements.

16. The test assembly to claim 15, wherein the carrier frame comprises a support bracket and a plurality of bearing members arranged along the first direction and connected to the support bracket;
each of the plurality of bearing members comprises a bearing portion and two extension portions, each of the sensing element is carried on the bearing member of a corresponding bearing member of the plurality of bearing members, the two extension portions are connected to respective opposite ends of the bearing portion along a third direction, forming a receiving groove receiving the plurality of test pieces along a second direction and accommodating the test piece, each of the second direction and the third direction is perpendicular to the first direction.

17. The test assembly to claim 16, wherein the extension portion comprises a telescopic member, wherein the telescopic member is configured to extend in responding to the receiving groove accommodating the transfer mechanism, and to stop the transfer mechanism from moving away from the receiving groove along the second direction.

18. The test assembly to claim 15, wherein the piping assembly comprises:
a plurality of first pipelines; wherein a plurality of groups of first pipelines comprising every two first pipelines of the plurality of first pipelines adjacent to both sides of the same sensing element is formed, the plurality of groups of first pipelines is arranged along the first direction, two first pipelines in each group of first pipelines are connected to a corresponding sensing element of the plurality of sensing elements, and at least one of the two first pipelines in each group is configured for connecting the supply member;
a plurality of second pipelines, two second pipelines of the plurality of second pipelines connected between the corresponding test piece and the sensing element, wherein a circulation passage of the plurality of circulation passages is from the sensing element to one of the two second pipelines to the corresponding test piece and reflowing to the sensing element via another one of the two second pipelines.

19. The test assembly to claim 18, wherein the carrier frame comprises a plurality of fastening clips arranged at intervals along the first direction, and the plurality of second pipelines is clamped to the plurality of fastening clips.

20. The test assembly to claim 19, wherein each of the plurality of fastening clips defines two clamping grooves, one clamping groove of the two clamping grooves extends along a second direction, and another of the two clamping grooves extends along a third direction, each of the second direction and the third direction are both perpendicular to the first direction, and the second pipelines is clamped in the clamping grooves.
